(19) United States
(12) Patent Application Publication
(10) Pub. No.: US 2025/0252778 A1
(43) Pub. Date: Aug. 7, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: KIMIMARU KATO, Tokyo (JP)

(21) Appl. No.: 19/045,934

(22) Filed: Feb. 5, 2025

(30) Foreign Application Priority Data
Feb. 7, 2024 (JP) 2024-017243

(51) Int. Cl. G06V 40/16; G06V 40/40

(52) U.S. Cl. CPC G06V 40/172; G06V 40/45

(57) ABSTRACT

An information processing apparatus includes a storage device that stores a biometric determination parameter to be used in determination as to whether a person appearing in an image is a living subject, a face recognition unit that performs face recognition, by comparing a face feature amount acquired from a face image of a recognition target and a face feature amount of a registered user, and a determination unit that determines whether the recognition target is a living subject, using the stored biometric determination parameter. The stored biometric determination parameter is determined based on a detection result of an eye opened/closed motion of the registered user. The determination unit determines whether the recognition target is a living subject, by comparing a detection result of a motion including eye opening/closing of the recognition target recognized by the face recognition as the registered user and the stored biometric determination parameter.

### BACKGROUND

### Field

The present disclosure relates to an information processing apparatus, an information processing method, and a storage medium for face recognition.

### Description of the Related Art

In recent years, face recognition has been widely used as means of personal identification and personal recognition. Furthermore, as a countermeasure against the use of photographs to impersonate a registered user, some systems that perform face recognition have a configuration that performs biometric determination as to whether a person appearing in an image (hereinafter referred to as a recognition target) is a living subject. The biometric determination as to whether a recognition target is a living subject is performed by, for example, requesting the recognition target to perform a specific operation, such as blinking or face orientation change, and checking whether the specific operation has been performed, based on images. In the case of checking whether the specific operation has been performed, a method is used of determining whether blinking has been performed by acquiring a score indicating an eye open degree or an eye open probability from images and comparing the score with a predetermined threshold value. To acquire a score indicating an eye open degree or an eye open probability from images, a configuration of using an algorithm, such as template matching or machine learning, for example, is often used.

In addition, as a method of performing determination related to eye opening/closing, Japanese Patent Application Laid-Open No. 2010-134490 discusses a method of learning eye-opened images and eye-closed images and determining threshold values for eye open determination and eye close determination based on these images. Furthermore, Japanese Patent Application Laid-Open No. 2007-151798 discusses a method of determining a threshold value based on a score frequency distribution in a certain period of time.

### SUMMARY

According to an aspect of the present disclosure, an information processing apparatus includes a storage device that stores a biometric determination parameter used in determining whether a person appearing in an image is a living subject, at least one memory storing instructions, and at least one processor that, upon execution of the stored instructions, causes the information processing apparatus to function as a face recognition unit that performs face recognition to determine whether a recognition target is a registered user by comparing a face feature amount acquired from a face image of the recognition target and a face feature amount of the registered user, and a determination unit that determines whether the recognition target recognized by the face recognition as the registered user is the living subject using the stored biometric determination parameter. The stored biometric determination parameter is determined based on a detection result of an eye opened/closed motion of the registered user. The determination unit determines whether the recognition target is the living subject, by comparing a detection result of a motion including eye opening/closing of the recognition target recognized by the face recognition as the registered user and the stored biometric determination parameter.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration applicable to an information processing apparatus according to a first exemplary embodiment.

FIG. 2 is a block diagram illustrating a functional configuration example of the information processing apparatus according to the first exemplary embodiment.

FIG. 3 is a diagram illustrating an example of registered information stored in a storage unit according to the first exemplary embodiment.

FIG. 4 is a conceptual diagram of an example of a system to which the information processing apparatus is applied, according to the first exemplary embodiment.

FIGS. 5A and 5B are diagrams each illustrating a face example and a transition example of an eye opened/closed score of each user according to the first exemplary embodiment.

FIG. 6 is a flowchart illustrating information registration processing according to the first exemplary embodiment.

FIG. 7 is a flowchart illustrating face recognition processing according to the first exemplary embodiment.

FIG. 8 is a flowchart illustrating biometric determination parameter determination processing according to the first exemplary embodiment.

FIG. 9 is a flowchart illustrating biometric determination processing according to the first exemplary embodiment.

FIG. 10 is a flowchart illustrating biometric determination parameter update processing according to the first exemplary embodiment.

FIG. 11 is a flowchart illustrating eye opened/closed score calculation processing according to the first exemplary embodiment.

FIG. 12 is a diagram illustrating images to be used in the description of eye opened/closed score calculation processing according to the first exemplary embodiment.

FIGS. 13A and 13B are diagrams each illustrating a face example and a transition example of uncorrected and corrected eye opened/closed scores of each user according to a second exemplary embodiment.

FIG. 14 is a flowchart illustrating biometric determination parameter determination processing according to the second exemplary embodiment.

FIG. 15 is a flowchart illustrating biometric determination processing according to the second exemplary embodiment.

FIG. 16 is a flowchart illustrating biometric determination parameter update processing according to the second exemplary embodiment.

FIG. 17 is a flowchart illustrating biometric determination parameter determination processing according to a third exemplary embodiment.

FIG. 18 is a flowchart illustrating biometric determination parameter update processing according to the third exemplary embodiment.

FIG. 19 is a flowchart illustrating biometric determination parameter determination processing according to a fourth exemplary embodiment.

FIG. 20 is a flowchart illustrating biometric determination processing according to the fourth exemplary embodiment.

FIG. 21 is a flowchart illustrating biometric determination parameter update processing according to the fourth exemplary embodiment.

### DESCRIPTION OF THE EMBODIMENTS

Hereinafter, exemplary embodiments of the present disclosure will be described with reference to the drawings. Each exemplary embodiment to be described below is not intended to limit the present disclosure. In addition, not all combinations of features described in the present exemplary embodiment are always essential to the solution of the present disclosure. The configurations of the exemplary embodiments can be appropriately modified or changed depending on the specification and various conditions (use condition, use environment, etc.) of an apparatus to which the present disclosure is applied. In addition, the exemplary embodiments to be described below may be partially combined. In the following exemplary embodiments, the redundant descriptions about the same or similar components or processing processes will be omitted.

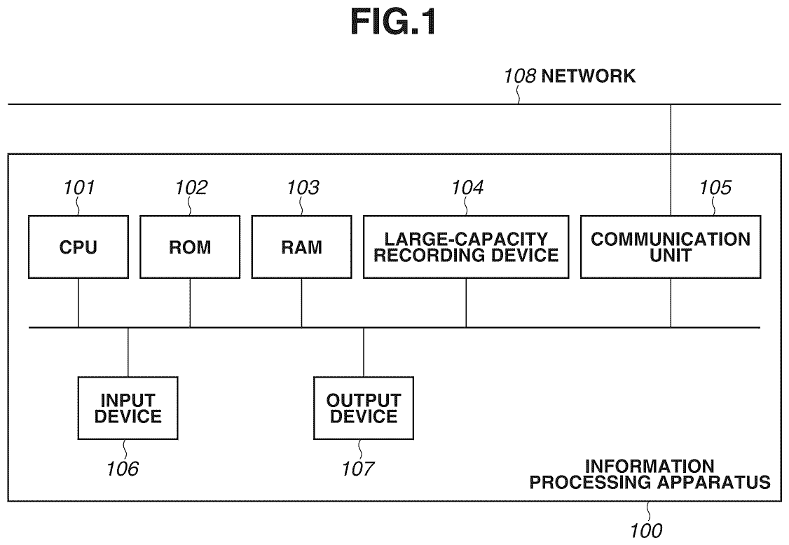

A first exemplary embodiment will be described. FIG. 1 is a diagram illustrating an example of a hardware configuration applicable to an information processing apparatus 100 according to the present exemplary embodiment. The information processing apparatus 100 includes, for example, a central processing unit (CPU) 101, a read-only memory (ROM) 102, a random access memory (RAM) 103, a large-capacity recording device 104, a communication unit 105, an input device 106, and an output device 107.

The communication unit 105 is connected to a network 108.

The CPU 101 executes various types of processing by reading control programs recorded on the ROM 102 and information processing programs according to the present exemplary embodiment. The RAM 103 is used as a main memory and a temporary storage region, such as a work area. The large-capacity recording device 104 is a hard disk drive (HDD) and a solid state drive (SSD), and is used for holding long-term data. The communication unit 105 is a circuit that performs communication via the network 108. The input device 106 is a device for inputting instructions and data to the information processing apparatus 100 from the outside. Specifically, the input device 106 includes a camera for acquiring images, and a keyboard, a mouse, and a touch panel for receiving inputs of users. The output device 107 is a device for outputting instructions and data to the outside from the information processing apparatus 100. Specifically, the output device 107 includes a display device, such as a display that displays recognition results and information for the user, and an interface for outputting recognition results and an unlocking signal to be issued at the time of recognition success to an external apparatus.

The information processing apparatus 100 does not needs include all of the components illustrated in FIG. 1.

For example, in a case where all inputs to and outputs from the outside are performed using another device mutually connected via the network 108, the input device 106 and the output device 107 are unnecessary. The information processing apparatus 100 may include a component not illustrated in FIG. 1. For example, the information processing apparatus 100 may include a graphics processing unit (GPU) that executes image processing, and a Field Programmable Gate Array (FPGA).

As described above, the hardware configuration of the information processing apparatus 100 includes hardware components similar to hardware components included in a personal computer (PC), a tablet terminal, and a smartphone. Thus, various functions to be carried out by the information processing apparatus 100 can be implemented as software operating on a PC or the like. By the CPU 101 executing information processing programs according to the present exemplary embodiment, the information processing apparatus 100 can implement various functional units of the information processing apparatus 100 and processing illustrated in each flowchart to be described below.

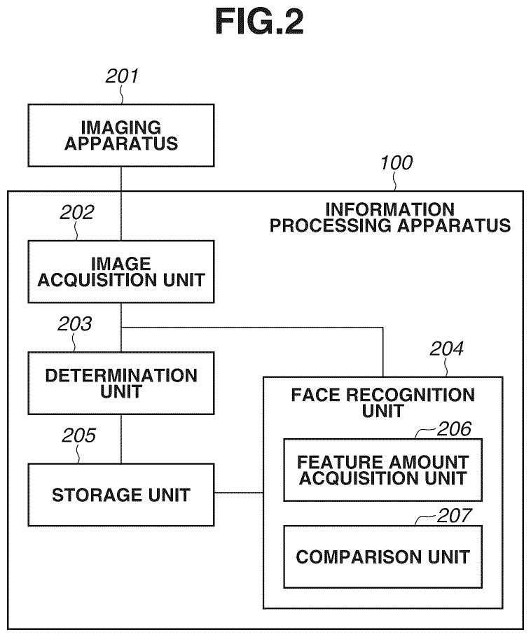

FIG. 2 is a functional block diagram illustrating functional units implemented in the information processing apparatus 100 according to the present exemplary embodiment. Each functional unit illustrated in FIG. 2 can be implemented by an element or a mechanical device, such as a CPU of a computer in terms of hardware, and can be implemented by computer programs in terms of software. FIG. 2 illustrates a functional block to be implemented by these operating in conjunction with each other. Thus, those skilled in the art understand that these functional blocks can be implemented in various forms with combinations of pieces of hardware and software.

As illustrated in FIG. 2, the information processing apparatus 100 includes functional units, such as an image acquisition unit 202, a determination unit 203, a face recognition unit 204, and a storage unit 205. The face recognition unit 204 includes a feature amount acquisition unit 206 and a comparison unit 207 as functional units. In addition, the information processing apparatus 100 is connected with an imaging apparatus 201 via the network 108. The information processing apparatus 100 and the imaging apparatus 201 may be connected via input-output interfaces included in the input device 106 and the output device 107, instead of the network 108.

Hereinafter, each functional unit will be described.

The imaging apparatus 201 is a camera that captures a still image and a moving image. The imaging apparatus 201 captures an image of a person targeted in face recognition (referred to as a recognition target), and transmits the image to the information processing apparatus 100 via the network 108. The image can be a moving image in an arbitrary format, such as Motion Joint Photographic Experts Group (JPEG) or H.264, or a still image in an arbitrary format, such as JPEG.

The image acquisition unit 202 acquires an image from the imaging apparatus 201 via the network 108.

Based on the image acquired by the image acquisition unit 202, the determination unit 203 performs biometric determination as to whether a person appearing in the image is an actual human being that is present and is not, for example, a photograph of the person, but a living subject. Details of the biometric determination processing to be performed by the determination unit 203 will be described below with reference to a flowchart.

The face recognition unit 204 performs face recognition based on the image acquired by the image acquisition unit 202. The face recognition unit 204 includes the feature amount acquisition unit 206 and the comparison unit 207. The feature amount acquisition unit 206 calculates a face feature amount using a pre-learned deep learning model from a face image included in the image acquired by the image acquisition unit 202. The comparison unit 207 acquires a matching score intercorrelated with a similarity degree by comparing two face feature amounts. In the present exemplary embodiment, the comparison unit 207 acquires a matching score by comparing a face feature amount registered in the storage unit 205, and a face feature amount calculated from an image or images acquired by the image acquisition unit 202. Details of the face recognition processing to be performed by the face recognition unit 204 will be described below with reference to a flowchart.

The storage unit 205 is a database storing registered information for face recognition. The registered information includes at least a face feature amount for face recognition, and a biometric determination parameter to be used in biometric determination. Aside from these, the registered information may include arbitrary information, such as a face image, a name, and identification information (ID) of an already-registered user (hereinafter, will be referred to as a registered user).

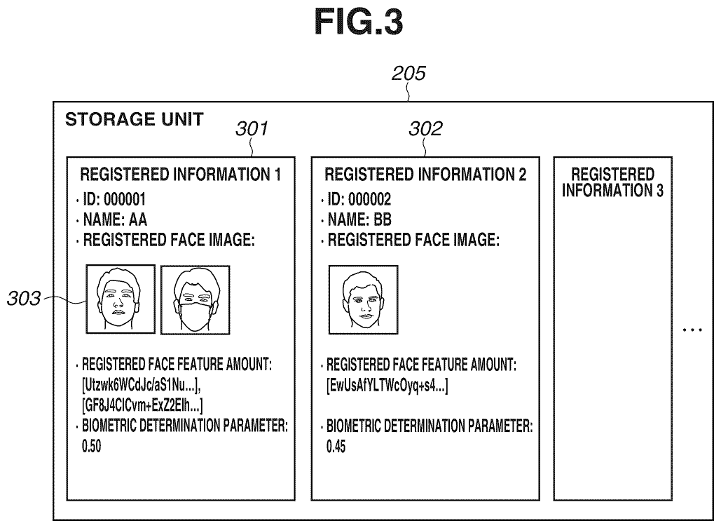

FIG. 3 is a diagram illustrating an example of registered information stored in the storage unit 205. Registered information 301 and registered information 302 each include an ID, a name, a registered face image 303, a registered face feature amount, and a biometric determination parameter of a registered user.

In the present exemplary embodiment, an example in which the storage unit 205 is used for a database constructed on the large-capacity recording device 104 will be described, but a configuration is not limited to this. For example, a mobile terminal or an integrated circuit (IC) chip-embedded ID card owned by a registered user may serve as the storage unit 205 and hold registered information for face recognition, and the information processing apparatus 100 may read the registered information via a reading device connected to the information processing apparatus 100.

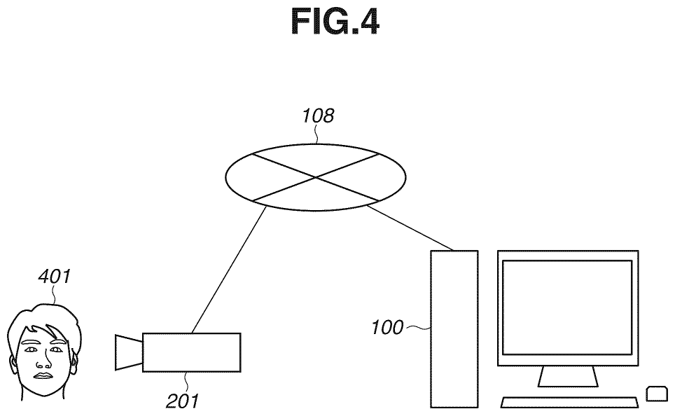

FIG. 4 is a conceptual diagram of an example of a system to which the information processing apparatus 100 is applied.

The imaging apparatus 201 captures images of a face of the recognition target 401. In some cases, the recognition target 401 is a registered user, and in other cases, the recognition target 401 is an unregistered person who has not been registered. The information processing apparatus 100 acquires a captured image of the face of the recognition target 401 from the imaging apparatus 201 via the network 108, and performs face recognition processing.

As a countermeasure against the use of photographs to impersonate a registered user, the information processing apparatus 100 according to the present exemplary embodiment performs biometric determination processing of determining whether the recognition target 401 is a living subject, together with the face recognition processing. In the biometric determination processing, the recognition target 401 is requested to perform a specific operation, such as blinking or face orientation change, and it is checked whether the specific operation has been performed based on an image or images. In the present exemplary embodiment, the description will be given using blinking as an example of as a specific operation that the recognition target 401 is requested to perform in biometric determination. The information processing apparatus 100 acquires an eye opened/closed score indicating a detection result of a detected eye opened degree or eye opened probability, from an image or images of the recognition target 401 that has or have been captured by the imaging apparatus 201, and determines whether blinking has been performed, by comparing the eye opened/closed score and a threshold value. In a case where blinking has been performed, the recognition target 401 can determine that the recognition target 401 is not a person appearing in a photograph, but a living subject. An opened/closed score indicating an eye opened degree or an eye opened probability can be acquired by a configuration of using an algorithm, such as template matching or machine learning.

In the first exemplary embodiment, the description will be given of an example of registering, as a biometric determination parameter, a threshold value serving as an eye opened/closed determination criterion in the information processing apparatus 100 that performs biometric determination by detecting the blinking of a recognition target.

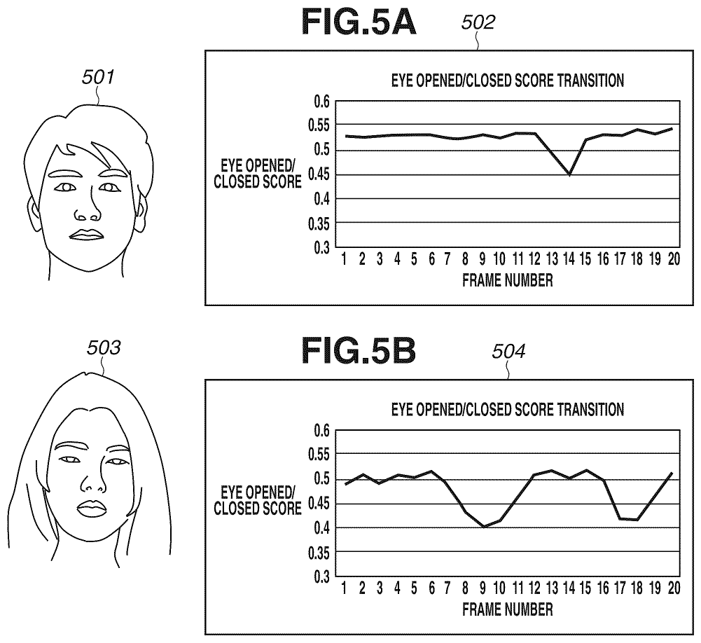

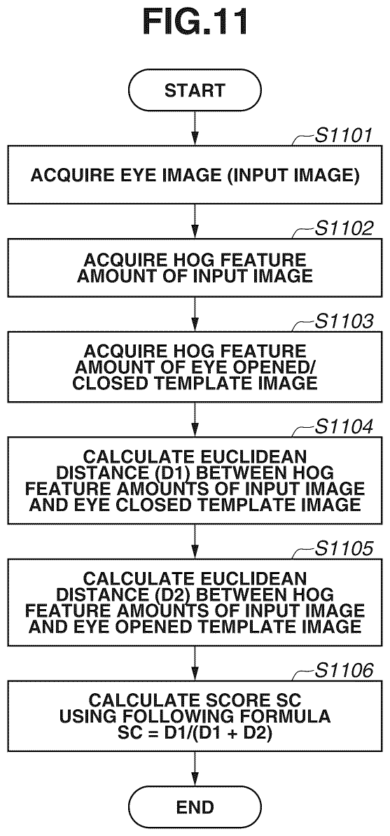

FIG. 5A is a diagram illustrating a set of the face of a person 501 and a graph 502 indicating a time-series transition of opened/closed scores indicating detection results of eye opened/closed motions of the person 501 that are calculated from each frame of a moving image. FIG. 5B is a diagram illustrating a set of the face of another person 503 and a graph 504 indicating a time-series transition of eye opened/closed scores of the person 503. The transition of the opened/closed score illustrated in the graph 502 indicates a time-series transition of opened/closed scores calculated by eye opened/closed score calculation processing illustrated in a flowchart in FIG. 11 to be described below from each frame image of a captured moving image of the person 501. Similarly, the graph 504 indicates a time-series transition of opened/closed scores calculated by the eye opened/closed score calculation processing illustrated in FIG. 11 from each frame image of a captured moving image of the person 503. The graph 502 indicates that the opened/closed score lowered by the person 501 blinking when the image of a frame number 14 is captured. Similarly, the graph 504 indicates that the opened/closed score lowered by the person 503 blinking when the images of frame numbers 9 and 18 are captured.

Here, in comparison of the graph 502 and the graph 502, the level of the opened/closed scores of the person 503 is lower than that of the person 501. This is probably attributed to the fact that eyes of the person 503 are narrower than those of the person 501 as a physical feature of the person 503. In this manner, a difference is found in the level of opened/closed scores depending on the physical feature of each user. Thus, in a case where an eye opened/closed motion is determined by comparing a general-purpose threshold value and an opened/closed score or opened/closed scores, there is a possibility that the determination fails to provide an accurate determination result.

In order to enable an accurate eye opened/closed determination based on an opened/closed score or opened/closed scores, a threshold value is applied that varies depending on the user in consideration of differences in level of opened/closed scores that is attributed to a physical feature of each user. For example, in the case of the graph 502 of the person 501, it is considered that setting a threshold value to a value near an opened/closed score value of 0.50 enables an eye opened/closed motion to be determined from opened/closed scores. On the other hand, in the case of the graph 504 of the person 503, it is considered that setting a threshold value to a value near an opened/closed score value of 0.50 is not appropriate, and setting a threshold value to a value near 0.45, for example, is more appropriate.

In view of the foregoing, the information processing apparatus 100 according to the first exemplary embodiment sets a threshold value to be used for eye opened/closed determination, to a value appropriate for each user, and the threshold value set for each user is included in registered information as a biometric determination parameter of the registered user and registered into the storage unit 205.

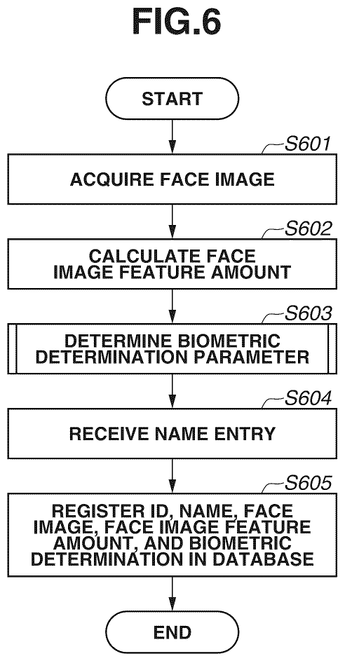

FIGS. 6 to 11 are flowcharts each illustrating a flow of information processing to be executed by the information processing apparatus 100 according to the present exemplary embodiment. Hereinafter, flows of information processing to be executed by the information processing apparatus 100 according to the present exemplary embodiment will be described with reference to these flowcharts. Further, the information processing apparatus 100 may not perform processes in all steps to be described with reference to these flowcharts.

FIG. 6 is a flowchart illustrating information registration processing to be executed in the information processing apparatus 100 by acquiring a face feature amount from a face image of a registered user, further acquiring a biometric determination parameter and information regarding the registered user, such as a name, and storing these into a database as registered information. In response to calling a function of the information registration processing from a user (hereinafter, registration target user) who wishes to be registered, for example, the information processing apparatus 100 starts the processing in the flowchart in FIG. 6. Calling the information registration processing function of the information processing apparatus 100 may be performed by a specific operator.

If the information registration processing in FIG. 6 is started, first of all, as processing in step S601, the image acquisition unit 202 acquires, from the imaging apparatus 201, a face image obtained by capturing an image of the face of the registration target user.

Next, as processing in step S602, the feature amount acquisition unit 206 calculates a feature amount of the acquired face image.

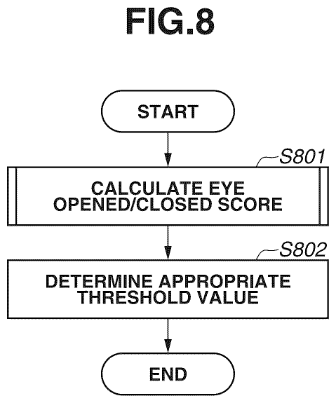

Next, as processing in step S603, the determination unit 203 determines a biometric determination parameter. Details of the biometric determination parameter determination processing in step S603 will be described below with reference to a flowchart in FIG. 8.

Furthermore, as processing in step S604, the information processing apparatus 100 prompts the registration target user to enter a name via the output device 107. The registration target user enters a name to be registered using the input device 106.

After that, as processing in step S605, the information processing apparatus 100 registers information, such as an ID, the face image, the feature amount of the face image, the biometric determination parameter, and the name that are obtained in steps S601 to S604, into the storage unit 205 (database) as registered information about the registration target user. The ID may be entered by the registration target user similarly to the name, or the information processing apparatus 100 may automatically determine a unique ID for a registered user on the database. If the registered information of the registration target user is registered in the database by the information registration processing, the information processing apparatus 100 thereafter regards the registration target user as a registered user.

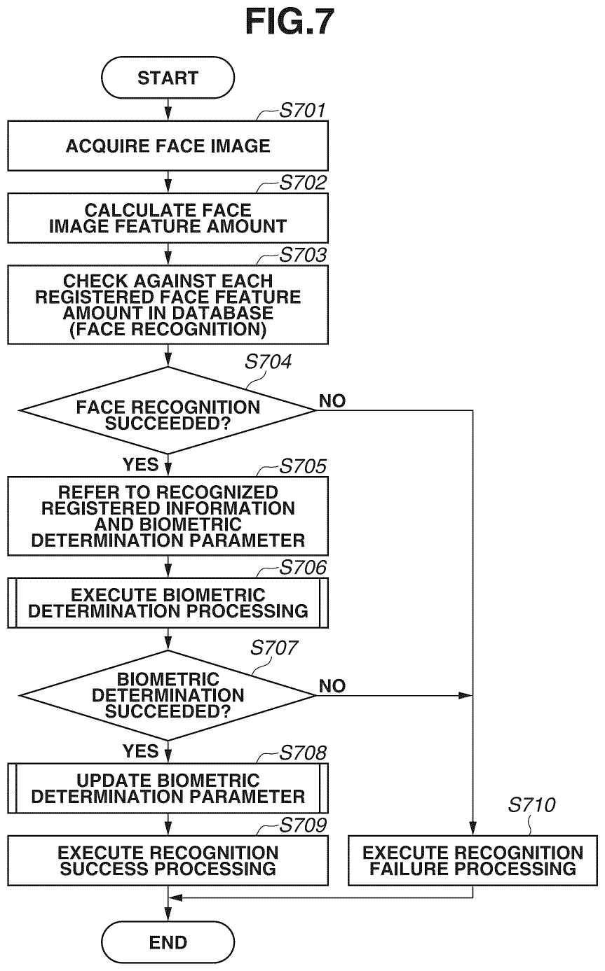

FIG. 7 is a flowchart illustrating face recognition processing to be performed by the face recognition unit 204 of the information processing apparatus 100. For example, in response to calling a face recognition function by a recognition target, the information processing apparatus 100 starts the processing in the flowchart in FIG. 7. In a case where the information processing apparatus 100 is used as a part of an entrance/exit gate of an entrance/exit system, for example, the information processing apparatus 100 may start the processing in the flowchart in FIG. 7 when recognition target's proximity to the entrance/exit gate is detected. In some cases, a recognition target is a registered user, and in other cases, the recognition target is an unregistered person.

If the face recognition processing in the flowchart in FIG. 7 is started, first of all, as processing in step S701, the image acquisition unit 202 acquires, from the imaging apparatus 201, a face image obtained by capturing an image of the face of the recognition target.

Next, as processing in step S702, the feature amount acquisition unit 206 calculates a feature amount of the face image of the recognition target.

Next, as processing in step S703, the comparison unit 207 calculates a matching score intercorrelated with a similarity degree by comparing the face feature amount of the recognition target calculated in step S702 and a registered face feature amount in each piece of registered information registered in the storage unit 205.

Then, as processing in step S704, the face recognition unit 204 determines whether a matching score with the highest score value of the matching scores calculated in step S703 is equal to or larger than a preset threshold value for matching scores. If the highest matching score is equal to or larger than the threshold value, the face recognition unit 204 determines that face recognition is successful, it is determined that the registered information including the registered face feature amount from which the matching score is calculated is registered information about the recognition target, and the processing proceeds to the next step S705. On the other hand, in a case where the highest matching score is smaller than the threshold value, the processing proceeds to step S710.

In a case where the processing proceeds to step S705, the information processing apparatus 100 refers to a biometric determination parameter in registered information stored in the storage unit 205, and refers to information, such as a name, as appropriate.

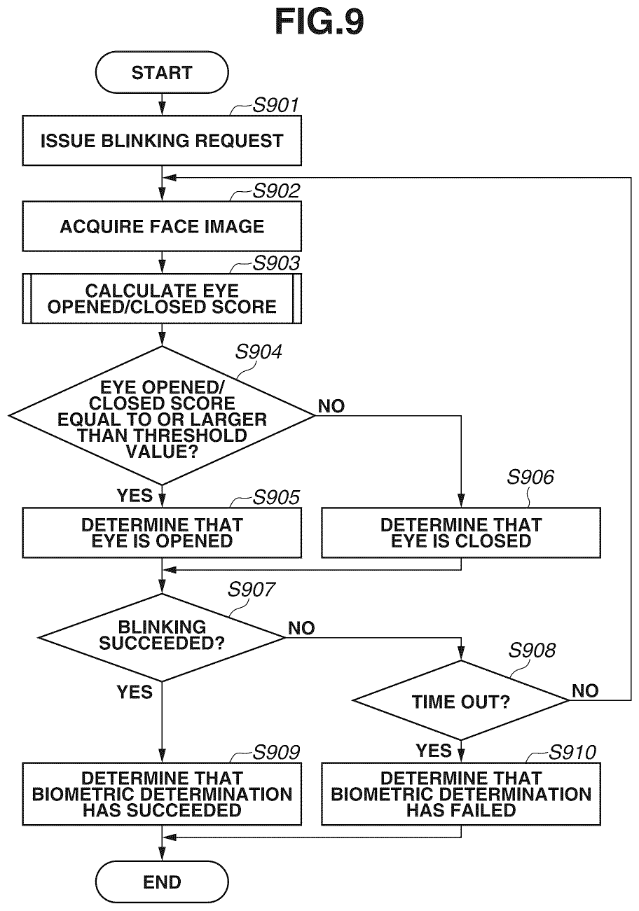

Next, as processing in step S706, the determination unit 203 performs biometric determination processing that uses the biometric determination parameter referred to from the storage unit 205. Details of the biometric determination processing in step S706 will be described below with reference to a flowchart in FIG. 9.

Next, as processing in step S707, the determination unit 203 checks whether the biometric determination is successful in the biometric determination processing in step S706. In a case where the determination is successful (YES in step S707), the processing proceeds to step S708. On the other hand, in a case where the biometric determination has failed (NO in step S707), the processing proceeds to step S710.

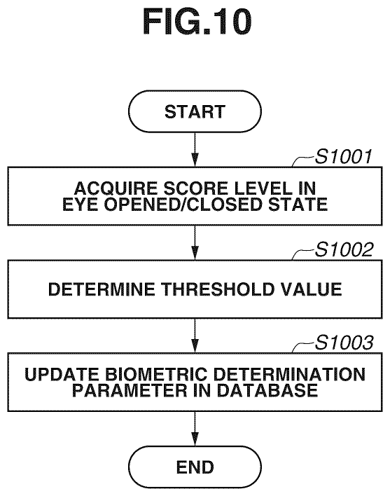

In a case where the processing proceeds to step S708, the determination unit 203 performs processing of updating the biometric determination parameter included in the registered information about the registered user. Details of the biometric determination parameter update processing in step S708 will be described below with reference to a flowchart in FIG. 10. Then, after step S708, the processing proceeds to step S709.

When the processing proceeds to step S709, the information processing apparatus 100 performs processing to be performed in a case where face recognition of a recognition target and biometric determination are successful. The processing to be performed in a case where face recognition and biometric determination are successful may be a desired processing. For example, in a case where the information processing apparatus 100 is used as a part of an entrance/exit gate of an entrance/exit system, the information processing apparatus 100 can notify the recognition target of a face recognition success via the output device 107, and can transmit an unlocking signal to the entrance/exit gate to be linked, for example.

On the other hand, in a case where the processing proceeds to step S710, the information processing apparatus 100 performs processing to be performed in a case where face recognition or biometric determination has failed. The processing to be performed in a case where face recognition or biometric determination has failed may also be a desired processing. For example, in a case where the information processing apparatus 100 is used as a part of an entrance/exit gate of an entrance/exit system, the information processing apparatus 100 can notify the recognition target of a face recognition failure via the output device 107, and transmit a signal indicating that the entrance/exit gate is not to be unlocked, for example.

FIG. 8 is a flowchart illustrating details of the biometric determination parameter determination processing to be performed by the determination unit 203 in step S603.

First of all, as processing in step S801, the determination unit 203 calculates an eye opened/closed score of the face image of the registration target user that has been acquired in step S601. Details of the eye opened/closed score calculation processing in step S801 will be described below with reference to a flowchart in FIG. 11.

Next, as processing in step S802, the determination unit 203 finds a threshold value to be used in determining an eye opened/closed motion based on the eye opened/closed score calculated in step S801, and determines the threshold value to be a biometric determination parameter.

Here, a registered face image of a registered user that is stored in the storage unit 205 as registered information is assumed to be registered as a good-condition face image in which the eyes are opened. Thus, the eye opened/closed score calculated in step S801 is assumed to be an opened/closed score in an opened state in which the eyes of the registration target user are opened.

Based on a relationship between opened/closed scores calculated in cases where eyes are in the opened state and threshold values suitable for opened/closed scores, the determination unit 203 finds a threshold value appropriate for an opened/closed score to be calculated in a case where the eyes of the registration target user are in the opened state. The relationship between opened/closed scores calculated in cases where eyes are in the opened state and threshold values suitable for opened/closed scores is experimentally obtained in advance. For example, it has been understood that, by acquiring time-series opened/closed score transitions including eye opening/closing like the graphs 502 and 504 for a plurality of persons, and using as a threshold value a value obtained by subtracting 0.05 from opened/closed scores in eye opened states based on these transitions, determination an eye opened/closed motion can be appropriately determined. Thus, in this case, the determination unit 203 acquires a value obtained by subtracting 0.05 from the opened/closed score calculated in step S801 as a threshold value to be used in determining an eye opened/closed motion of the registration target user, and determines the threshold value to be a biometric determination parameter.

As in the registered face image 303 illustrated in FIG. 3, some registered users register a plurality of face images as registered face images. In such a case, the determination unit 203 may calculate an opened/closed score for each face image in step S801, find a threshold value for each/close score in step S802, further determine a biometric determination parameter by setting the average value of the plurality of threshold values as a final threshold value. Further, as another method, the determination unit 203 may check a condition, such as face orientations on a plurality of face images of a registered user, and determine a biometric determination parameter serving as a threshold value by performing the processing in the flowchart in FIG. 8 based on the best-condition face image alone.

FIG. 9 is a flowchart illustrating details of the biometric determination processing to be performed by the determination unit 203 in step S706.

First of all, as processing in step S901, the determination unit 203 requests a recognition target to perform blinking via the output device 107. The blinking request to the recognition target is made by displaying a message “please blink” on a display included in the output device 107, for example.

Then, as processing in step S902, the image acquisition unit 202 acquires a face image obtained by the imaging apparatus 201 capturing an image of the face of the recognition target.

Next, as processing in step S903, similarly to step S801, the determination unit 203 calculates an eye opened/closed score based on the face image acquired in step S902. Details of the eye opened/closed score calculation processing in step S903 will be described below with reference to a flowchart in FIG. 11.

Furthermore, as processing in step S904, the determination unit 203 compares the opened/closed score calculated in step S903 with the threshold value referred to as the biometric determination parameter in step S705. Then, if the opened/closed score is equal to or larger than the threshold value (YES in step S904), the processing proceeds to step S905. In step S905, the determination unit 203 determines that the eyes of the recognition target are in the opened state. On the other hand, if the opened/closed score is smaller than the threshold value (NO in step S904), the processing proceeds to step S906. In step S906, the determination unit 203 determines that the eyes of the recognition target are in the closed state.

Next, as processing in step S907, the determination unit 203 determines whether the recognition target has succeeded in blinking. For example, if it is determined in step S906 that the eyes of the recognition target are in the closed state, the determination unit 203 may determine that blinking has succeeded. Further, the determination unit 203 may chronologically store eye states of the recognition target, and determine that blinking has succeeded, when a state transition from the opened state to the closed state and then to the opened state is made. Then, in a case where the determination unit 203 determines that the recognition target has succeeded in blinking (YES in step S907), the processing proceeds to step S909. On the other hand, in a case where the determination unit 203 does not determine that the recognition target has succeeded in blinking (NO in step S907), the processing proceeds to step S908.

In a case where the processing proceeds to step S908, the determination unit 203 determines whether the biometric determination processing has timed out. For example, in a case where blinking has not succeeded for ten seconds since a blinking request was transmitted to the recognition target in step S901, the determination unit 203 may determine that the biometric determination processing has timed out. In a case where the determination unit 203 determines that the biometric determination processing has timed out (YES in step S908), the processing proceeds to step S910. On the other hand, in a case where the determination unit 203 determines that the biometric determination processing has not timed out (NO in step S908), the processing returns to step S902. Thereafter, the next image is acquired in step S902, and the processing in step S903 and subsequent steps that is similar to the above-described processing is performed.

In a case where the processing proceeds to step S909, the determination unit 203 determines that the biometric determination of the recognition target has succeeded, and determines that the recognition target serving as a subject is a living subject (i.e., the recognition target is not a photograph but a registered user being a living subject.

On the other hand, in a case where the processing proceeds to step S910, the determination unit 203 determines that the biometric determination of the recognition target has not succeeded. More specifically, in this case, the determination unit 203 determines that a face image of the recognition target is not a face image of a registered user being a living subject. This can prevent an unregistered user from impersonating a registered user in order to pass face recognition using a face photograph of the registered user.

FIG. 10 is a flowchart illustrating details of processing of updating a biometric determination parameter in registered information about a registered user to be performed by the determination unit 203 in step S708. The biometric determination parameter update processing illustrated in FIG. 10 is performed when the determination unit 203 determines in the above-described processing in the flowchart in FIG. 7 that a recognition target is a registered user being a living subject.

First of all, as processing in step S1001, the determination unit 203 refers to the value of the opened/closed score calculated from the face image of the recognition target in step S903 in the biometric determination processing in step S706, i.e., the value of the eye opened/closed score of the registered user being the recognition target who has succeeded in biometric determination in step S909 of FIG. 9. At the same time, the determination unit 203 also refers to the result of determination as to whether the eye state determined based on the opened/closed score is an opened state or a closed state. Then, the determination unit 203 acquires a level of the opened/closed scores in a state in which the eyes of the registered user that have succeeded in biometric determination are in the opened state (for example, the average value of the opened/closed scores determined to indicate the opened state) and a level of the opened/closed scores in a state in which the eyes of the registered user are in the closed state (similarly, the average value of the opened/closed scores determined to indicate the closed state).

Next, as processing in step S1002, the determination unit 203 determines a threshold value appropriate for the registered user whose opened/closed score has been acquired in step S1001. As a determination method for the threshold value, a method similar to or different from that in step S802 may be used. For example, similarly to the example of the processing in step S802, the determination unit 203 may set as a threshold value a value obtained by subtracting 0.05 from the level of the opened/closed score in the eye opened state of the registered user that has been acquired in step S1001. Further, unlike the example in the processing in step S802, the determination unit 203 may set as a threshold value a value exactly intermediate between the level of the opened/closed score in the eye opened state of the registered user that has been acquired in step S1001 and a level of an opened/closed score in the eye closed state.

Then, as processing in next step S1003, the determination unit 203 registers the threshold value determined in step S1002 in the storage unit 205 (database) as a biometric determination parameter of the registered user. The biometric determination parameter update processing is performed by an already-registered threshold value being overwritten.

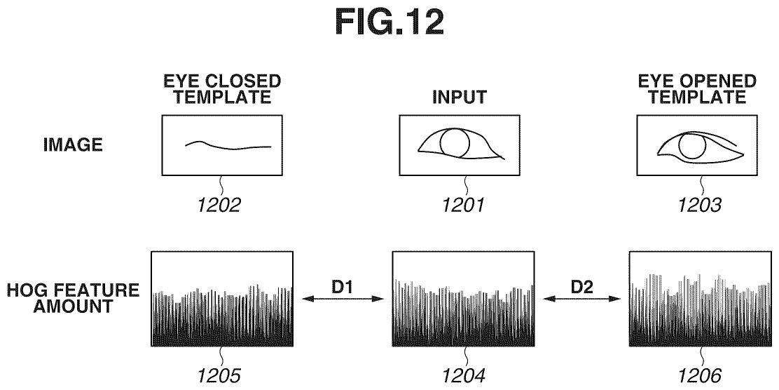

FIG. 11 is a flowchart illustrating details of eye opened/closed score calculation processing to be performed by the determination unit 203 in step S801 or S903 based on a face image. FIG. 12 is a diagram to be used in the description of the concept of the eye opened/closed score calculation processing.

First of all, as processing in step S1101, the determination unit 203 generates an input image by extracting an eye region from the face image. An input image 1201 in FIG. 12 indicates an example of an input image generated by the determination unit 203 in step S1101 by extracting an eye region from a face image. The input image 1201 indicates an example of an image in an eye opened state, but in a case where an eye in a face image is closed, an input image is generated by extracting an eye region from the face image in the eye closed state.

Next, as processing in step S1102, the determination unit 203 calculates a histograms of oriented gradients (HOG) feature amount of the input image 1201. A HOG feature amount 1204 in FIG. 12 indicates an example of a feature amount calculated by the determination unit 203 from the input image 1201.

Next, as processing in step S1103, the determination unit 203 acquires HOG feature amounts of an eye opened and closed template images. The eye opened template image is a template image in a human-eye opened state that is preliminarily held by the information processing apparatus 100. The eye opened template image may be generated by a desired method. For example, the eye opened template image may be a template image in a typical human-eye opened state that is generated by a computer graphics or based on an image in an eye opened state obtained by capturing a person. Similarly, the eye closed template image is a template image in a human-eye closed state that is preliminarily held by the information processing apparatus 100. The eye closed template image can be generated by a desired method. For example, the eye closed template image may be a template image in a typical human-eye closed state that is generated by a computer graphics, or based on an image in an eye closed state obtained by capturing a person. An opened template image 1203 illustrated in FIG. 12 is an example of an eye opened template image, and a closed template image 1202 illustrated in FIG. 12 is an example of an eye closed template image.

The determination unit 203 acquires HOG feature amounts of both the eye opened template image and the closed template image. A feature amount 1205 illustrated in FIG. 12 indicates an example of an HOG feature amount calculated from the closed template image 1202, and a feature amount 1206 indicates an example of an HOG feature amount calculated from the opened template image 1203. The information processing apparatus 100 may hold HOG feature amounts alone calculated from eye opened and closed template images without holding the eye opened and closed template images. In this case, in step S1103, the determination unit 203 acquires the held HOG feature amounts instead of calculating HOG feature amounts from template images.

Next, as processing in step S1104, the determination unit 203 calculates a Euclidean distance D1 between HOG feature amounts, i.e., the HOG feature amount 1204 calculated from the input image 1201 and the HOG feature amount 1205 calculated from the eye closed template image 1202.

Similarly, as processing in step S1105, the determination unit 203 calculates a Euclidean distance D2 between HOG feature amounts, i.e., the HOG feature amount 1204 of the input image 1201 and an HOG feature amount 1206 of the eye opened template image 1203.

Next, as processing in step S1106, the determination unit 203 calculates an opened/closed score SC using an opened/closed score calculation formula represented by the following formula (1).

$$SC = D 1 / ( D 1 + D 2 ) \qquad ( 1 )$$

Here, the image shapes of the input image 1201 in the eye opened state and the eye opened template image 1203 are close to each other, so the Euclidean distance D2 is small. In contrast, the image shapes of the input image 1201 in the eye opened state and the eye closed template image 1202 are different from each other, the Euclidean distance D1 is large. Thus, in a case where the input image 1201 in the eye opened state is acquired in step S1101, the opened/closed score SC calculated by the opened/closed score calculation formula represented by Formula (1) is large. In contrast to this, for example, in a case where an input image in the eye closed state is acquired, the Euclidean distance D2 between the input image and the eye opened template image 1203 is large, and in contrast, the Euclidean distance D1 between the input image and the eye closed template image 1202 is small. Thus, in a case where the input image 1201 in the eye closed state is acquired in step S1101, the opened/closed score SC calculated by the opened/closed score calculation formula represented by Formula (1) is small.

In view of the foregoing, the opened/closed score SC indicates a higher likelihood of an eye in an input image being in an opened state, as its value becomes larger.

In step S1106, the determination unit 203 may prepare a plurality of sets of eye opened and closed template images, calculate the opened/closed scores of the sets, and then calculate the average value of these as a final opened/closed score SC. In addition, the determination unit 203 may calculate the opened/closed score SC of any one of a right eye and a left eye, or may calculate opened/closed scores SC of the average the scores of both eyes.

The processing in the flowchart illustrated in FIG. 11 is an example of processing of calculating an eye opened/closed score, and the determination unit 203 may calculate an eye opened/closed score using another known method. For example, the determination unit 203 may detect upper and lower eyelids using a deep learning model that can execute face organ point detection or an algorithm that is based on an image brightness gradient, and calculate an eye opened/closed score based on a distance between the upper and lower eyelids. Aside from these, the determination unit 203 may implement a learner that learns a plurality of eye opened and closed images, and output a likelihood of an input image being an eye opened image, as an opened/closed score. Examples of the learner in this case include a learner that uses an algorithm, such as Deep Learning or a support vector machine (SVM). Images to be used in the learning may be generated using a desired method, like the above-described closed template image 1202 and the opened template image 1203.

As described above, the information processing apparatus 100 according to the first exemplary embodiment enables application of an appropriate biometric determination parameter suitable for an individual user in biometric determination involved in face recognition more swiftly without placing a burden on the user.

In a second exemplary embodiment, the description will be given of an example of registering as a biometric determination parameter a coefficient of a correction formula that normalizes or corrects an opened/closed score. A hardware configuration applicable to an information processing apparatus 100 according to the second exemplary embodiment is similar to the above-described hardware configuration illustrated in FIG. 1, functional blocks are similar to those illustrated in FIG. 2, and an applicable example of the information processing apparatus 100 is similar to that illustrated in FIG. 4. Thus, the illustration and the description of these will be omitted. In the information processing apparatus 100 according to the second exemplary embodiment, registered information is approximately similar to the example illustrated in FIG. 3, a flowchart of information registration processing is approximately similar to that illustrated in FIG. 6, and a flowchart of face recognition processing is approximately similar to that illustrated in FIG. 7. Thus, the illustration of these will be omitted.

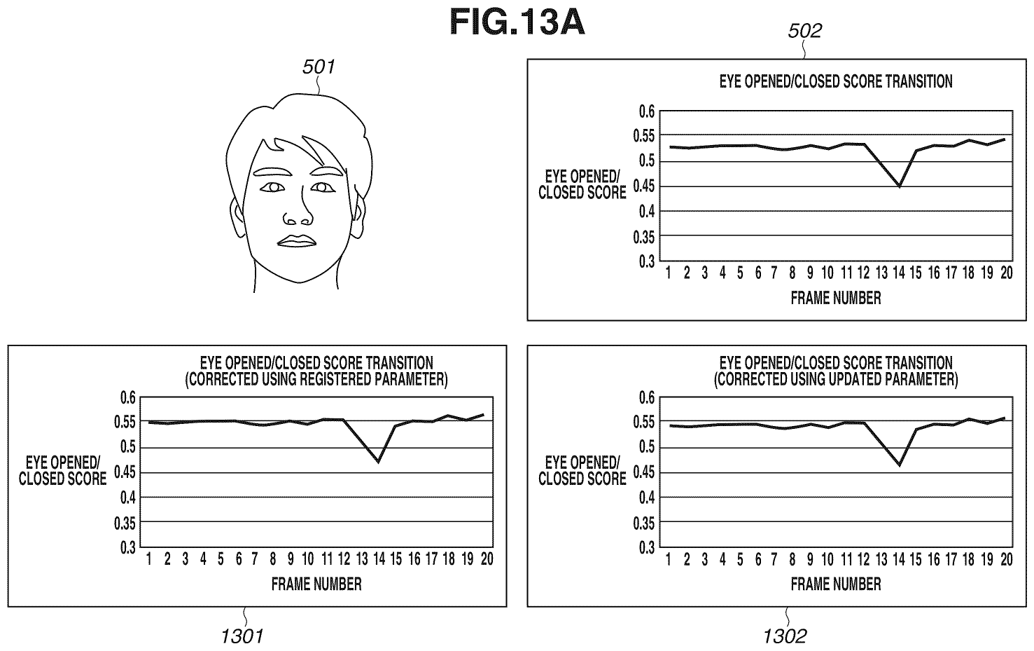

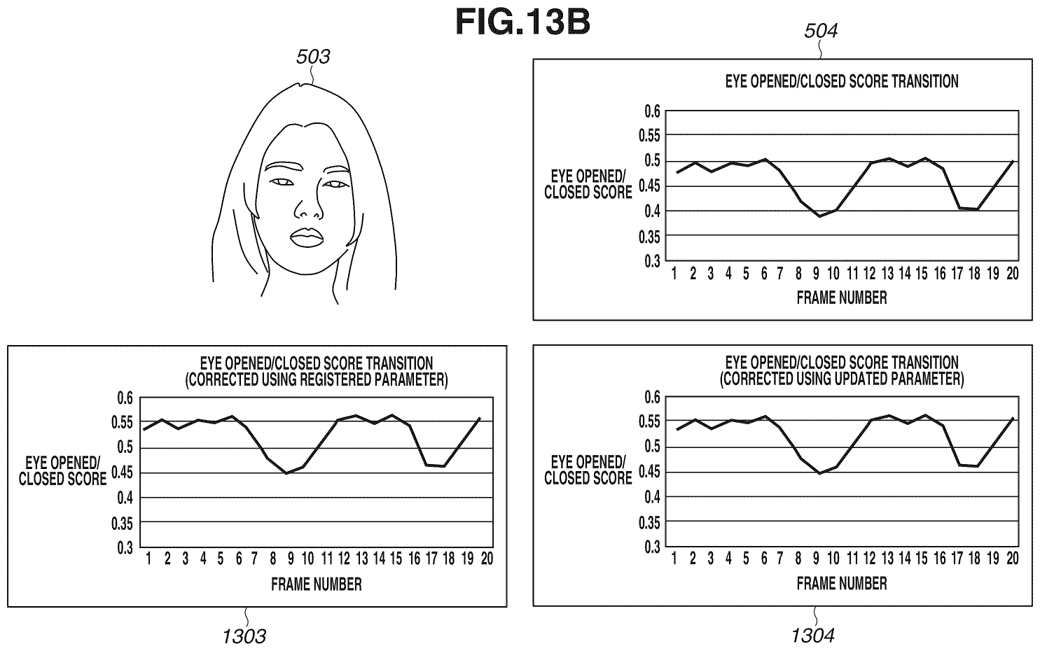

FIGS. 13A and 13B are diagrams to be used in the description of an example of an opened/closed score appropriately corrected for each user in the information processing apparatus 100 according to the second exemplary embodiment. A person 501 and a graph 502 in FIG. 13A are similar to those in the example illustrated in FIG. 5A, and a person 503 and a graph 504 in FIG. 13B are similar to those in the example illustrated in FIG. 5B, the description of these will be omitted. As described with reference to FIGS. 5A and 5B, the person 501 and the person 503 differ in level of opened/closed scores, and it is difficult to accurately determine an eye opened/closed motion in the determination that uses a predetermined threshold value.

While a threshold value is determined in the above-described first exemplary embodiment, in the second exemplary embodiment, each opened/closed score is corrected (normalized) in such a manner that the level of opened/closed scores in the eye opened state is about 0.55 and the level of opened/closed scores in the eye closed state is about 0.45 for any person. In other words, by correcting (normalizing) an opened/closed score, the information processing apparatus 100 according to the second exemplary embodiment enables an eye opened/closed motion to be accurately determined using a predetermined threshold value (e.g., 0.50).

A graph 1301 in FIG. 13A indicates an example of an opened/closed score transition after the level of the opened/closed scores in the eye opened state that is indicated by the graph 502 is corrected to about 0.55. Similarly, a graph 1303 in FIG. 13B indicates an example of an opened/closed score transition after the level of the opened/closed scores in the eye opened state that is indicated by the graph 504 is corrected to about 0.55.

A graph 1302 in FIG. 13A indicates an example of an opened/closed score transition after the level of the opened/closed scores in the eye opened state is corrected to about 0.55 and the level of the opened/closed score in the eye closed state is corrected to about 0.45 from the level of the opened/closed scores in the eye opened state that is indicated by the graph 502.

Similarly, a graph 1304 in FIG. 13B indicates an example of an opened/closed score transition after the level of the opened/closed scores in the eye opened state is corrected to about 0.55 and the level of the opened/closed scores in the eye closed state is corrected to about 0.45 from the level of opened/closed scores in the eye opened state that is indicated by the graph 504.

Details of processing of correcting the level of opened/closed scores will be described below.

In this manner, the information processing apparatus 100 according to the second exemplary embodiment registers as a parameter a coefficient of a correction formula for correcting the level of opened/closed scores for each user.

Hereinafter, the information processing apparatus 100 according to the second exemplary embodiment that appropriate corrects the level of opened/closed scores for each user will be described mainly based on a difference from the first exemplary embodiment.

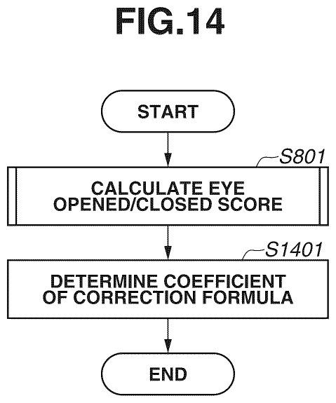

FIG. 14 is a flowchart illustrating details of biometric determination parameter determination processing to be performed by the determination unit 203 in step S603 of FIG. 6 in the information processing apparatus 100 according to the second exemplary embodiment. The processing in step S801 is similar to the processing described in the first exemplary embodiment, the description will be omitted.

If the processing proceeds to step S1401 after step S801, the determination unit 203 determines a coefficient of a correction formula for correcting the eye opened/closed score calculated in step S801, as a biometric determination parameter. Here, similarly to the foregoing, a registered face image for face recognition of a registered user that is stored in the storage unit 205 as registered information is assumed to be registered as a good-condition face image in which the eyes are opened. In addition, the eye opened/closed score calculated in step S801 is assumed to be an opened/closed score SC1 in the opened state in which the eyes are opened. Based on these, the determination unit 203 determines a coefficient of a correction formula for correcting an opened/closed score in such a manner that the level of opened/closed scores in the eye opened state is about 0.55. Specifically, using a calculation formula represented by the following formula (2), the determination unit 203 determines a coefficient a and a coefficient b of a correction formula for correcting an opened/closed score SC to a corrected opened/closed score SCc. For example, the coefficient a is set to 1 and the coefficient b is calculated by the following formula (3).

$$S C c = a \cdot SC + b \qquad ( 2 )$$

$$B = 0.55 - SC 1 \qquad ( 3 )$$

As in the registered face image 303 illustrated in FIG. 3, some registered users register a plurality of face images as registered face images. In such a case, the determination unit 203 may calculate an opened/closed score for each face image in step S801, and in the processing in step S1401, calculate a coefficient of a correction formula for each face image, and further determine a biometric determination parameter by determining an average value of these to be a final coefficient. Further, in the processing in step S801, the determination unit 203 may calculate an opened/closed score for each face image, determine that an average value of these is an opened/closed score SC1 in the eye opened state of the registered user, and further perform coefficient calculation in stat S1401. As another method, the determination unit 203 may check a condition, such as face orientations for a plurality of face images of a registered user, and determine a coefficient by performing the processing in the flowchart in FIG. 14 based on the best-condition face image alone.

After the biometric determination parameter determination processing illustrated in FIG. 14, in step S605 of FIG. 6 in the second exemplary embodiment, the information processing apparatus 100 registers the coefficient a and the coefficient b of the correction formula obtained in the processing in step S1401 in the storage unit 205 (database) as biometric determination parameters.

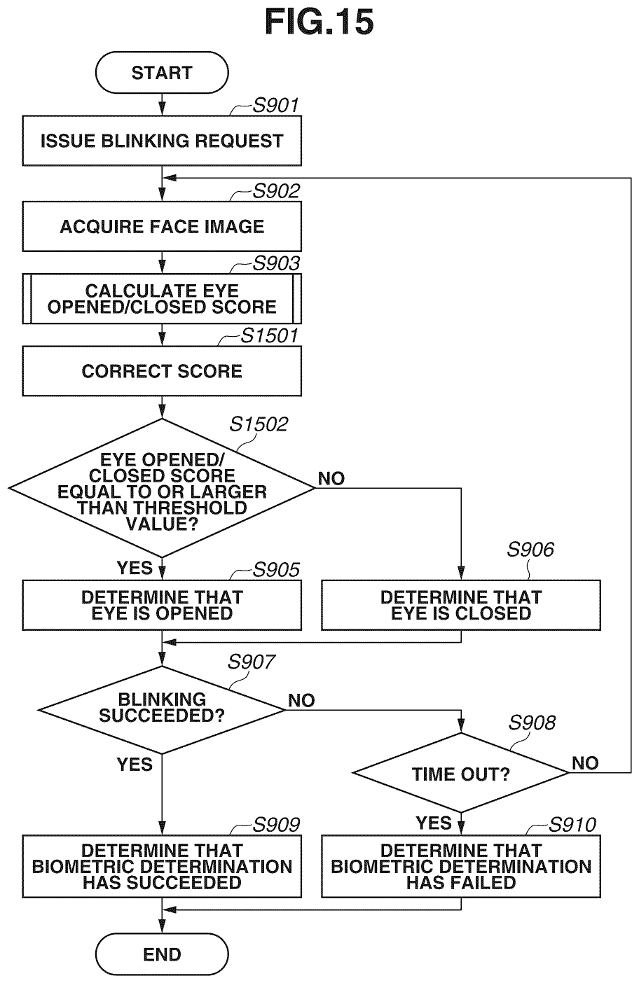

FIG. 15 is a flowchart illustrating details of the biometric determination processing to be performed by the determination unit 203 in step S706 of FIG. 7 in the information processing apparatus 100 according to the second exemplary embodiment. The processing in steps S901 to S903 and S905 to S910 is similar to the processing described in the first exemplary embodiment, the description thereof will be omitted. In the second exemplary embodiment, after the processing in step S903, the determination unit 203 performs processing in step S1501 and further performs processing in step S1502.

As processing in step S1501, the determination unit 203 corrects an eye opened/closed score obtained in step S903. Specifically, the determination unit 203 calculates the corrected opened/closed score SCc based on the opened/closed score SC obtained in step S903, the coefficient a and the coefficient b determined to be biometric determination parameters and stored in the storage unit 205 in step S705, and the above-described formula (2).

Next, as processing in step S1502, the determination unit 203 compares the corrected opened/closed score SCc calculated in step S1501 with a predetermined threshold value (e.g., 0.50). Then, if the corrected opened/closed score SCc is equal to or larger than the threshold value (YES in step S1502), the processing proceeds to step S905. On the other hand, if the corrected opened/closed score SCc is smaller than the threshold value (NO in step S1502), the processing proceeds to step S906. The subsequent processing is similar to the above-described processing.

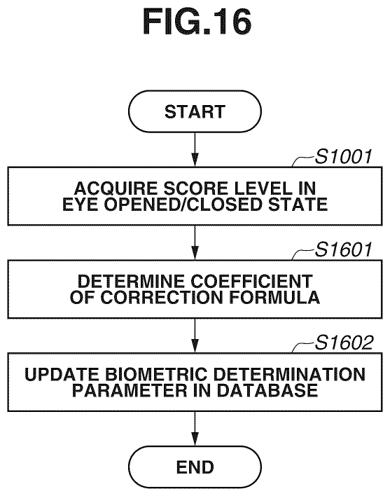

FIG. 16 is a flowchart illustrating details of the biometric determination parameter update processing to be performed by the determination unit 203 in step S708 of FIG. 7 in the information processing apparatus 100 according to the second exemplary embodiment. The biometric determination parameter update processing illustrated in FIG. 16 is performed when the determination unit 203 determines that a recognition target is a registered user being a living subject in the above-described processing in the flowchart illustrated in FIG. 7.

First of all, as the above-described processing in step S1001, the determination unit 203 obtains a level of an opened/closed score in a state in which the eyes of a recognition target are in the opened state (for example, an average value of opened/closed scores determined to indicate the opened state) and a level of an opened/closed score in a state in which the eyes are in the closed state (for example, an average value of opened/closed scores determined to indicate the closed state). Here, the level of the opened/closed score in the eye opened state is denoted by SC1, and the level of the opened/closed score in the eye closed state is denoted by SC2.

Next, as processing in step S1601, the determination unit 203 determines a coefficient of a correction formula for correcting an opened/closed score. As a determination method for the coefficient, a method similar to or different from that in step S1401 may be used. For example, similarly to the example of the processing in step S802, the determination unit 203 calculates the coefficient b using the calculation formula represented by Formula (3) from the level SC1 of the opened/closed score in the eye opened state obtained in step S1001, and sets the coefficient a to 1.

Further, the determination unit 203 may determine the coefficient a and the coefficient b of the correction formula using the following formulae (4) and (5) in such a manner that the level of the opened/closed scores in the eye opened state is about 0.55 and the level of the opened/closed scores in the eye closed state is about 0.45, from the level SC1 and the level SC2 of opened/closed scores.

$$a = 0.1 / ( SC 1 - SC 2 ) \qquad ( 4 )$$

$$b = 0. 55 - a \cdot SC 1 \qquad ( 5 )$$

Next, as processing in step S1602, the determination unit 203 registers the coefficients of the correction formula that have been determined in step S1601 in the storage unit 205 (database) as biometric determination parameters. In other words, the determination unit 203 updates the biometric determination parameter by overwriting an already-registered threshold value.

In a third exemplary embodiment, the description will be given of an example of registering an eye opened template image and an eye closed template image, both of which are appropriate for each user as biometric determination parameters. A hardware configuration, functional blocks, and an example applicable to an information processing apparatus 100 according to the third exemplary embodiment are similar to those described above with reference to FIGS. 1, 2 and 4. Thus, the illustration and the description of these will be omitted. Registered information, a flowchart of information registration processing, and a flowchart of face recognition processing are approximately similar to those illustrated in FIGS. 3, 6, and 7. Thus, the illustration of these will be omitted.

In the third exemplary embodiment, as eye opened and closed template images (for example, the closed template image 1202 and the opened template image 1203 in FIG. 12) to be used in the eye opened/closed score calculation illustrated in FIG. 11, an eye closed image and an eye opened image of a registered user are registered and used. This configuration in the third exemplary embodiment enables calculation of an opened/closed score based on which an eye opened/closed motion can be accurately determined irrespective of users.

Hereinafter, the information processing apparatus 100 according to the third exemplary embodiment that registers and uses an eye closed image and an eye opened image of a registered user as biometric determination parameters will be described mainly based on a difference from the first exemplary embodiment.

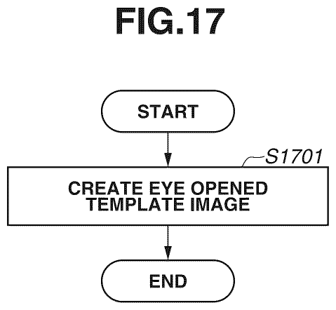

FIG. 17 is a flowchart illustrating details of the biometric determination parameter determination processing to be performed by the determination unit 203 in step S603 in the information processing apparatus 100 according to the third exemplary embodiment.

As processing in step S1701, the determination unit 203 generates an eye opened template image based on a face image acquired in step S601, and determines the eye opened template image to be a biometric determination parameter to be registered. Specifically, as a registered face image for face recognition of a registered user, a good-condition face image in which the eyes are opened is assumed to be registered. Similarly to the processing in step S1101, the determination unit 203 generates an image by extracting an eye region from the face image acquired in step S601, and determines the image to be an eye opened template image.

As in the registered face image 303 illustrated in FIG. 3, some registered users register a plurality of face images as registered face images. In this case, the determination unit 203 performs average processing on eye opened template images obtained from the plurality of face images, and determine a resultant average image to be a final eye opened template image. In this case, before performing the average processing, the determination unit 203 may perform preprocessing of aligning a position and a scale based on the position and the scale of a black eye. Alternatively, similarly to step S801, the determination unit 203 may calculate an opened/closed score for each face image using a prestored general-purpose template image, and generate an eye opened template image based on a face image of which the opened/closed score is the highest. Similarly, the determination unit 203 may check a condition, such as face orientations for a plurality of face images, and generate an eye opened template image based on the best-condition face image alone. Furthermore, in a case where a configuration for calculating an eye opened/closed score based on a plurality of sets of eye opened and closed templates is employed, the determination unit 203 may generate template images for a plurality of eyes from a plurality of face images.

After the biometric determination parameter determination processing illustrated in FIG. 17, as processing in step S605 of FIG. 6 in the third exemplary embodiment, the information processing apparatus 100 registers the eye opened template image obtained in step S1701 in the storage unit 205 (database) as a biometric determination parameter.

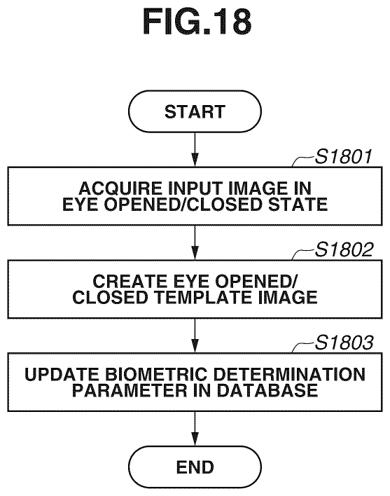

FIG. 18 is a flowchart illustrating details of the biometric determination parameter update processing to be performed by the determination unit 203 in step S708 in the information processing apparatus 100 according to the third exemplary embodiment. The biometric determination parameter update processing in FIG. 18 is performed when the determination unit 203 determines that a recognition target is a registered user being a living subject in the above-described processing in the flowchart illustrated in FIG. 7.

First of all, as processing in step S1801, the determination unit 203 acquires an input image (image obtained by extracting an eye region from a face image) generated in step S1101 in the biometric determination processing in step S706. At the same time, the determination unit 203 also refers to a determination result indicating an eye state determined based on the input image to be an opened state or a closed state.

Next, as processing in step S1802, the determination unit 203 generates an eye opened or eye closed template image based on the input image acquired in step S1801 on the input image of which the eye state is determined to be an opened state or a closed state. In a case where a plurality of input images is acquired in step S1801, similarly to the processing in step S1701, a better image may be selected and determined to be a template image, or a part or all of a plurality of input images may be determined to be template images.

Next, as processing in step S1803, the determination unit 203 registers the template image generated in step S1802 in the storage unit 205 (database) as a biometric determination parameter. At this time, an already-registered template image may be overwritten with the template image or a new template image may be added in addition to an already-registered template image.

As described above, in the processing of step S705, the information processing apparatus 100 according to the third exemplary embodiment refers to a template image as a biometric determination parameter of each user. The information processing apparatus 100 also calculates an opened/closed score using the template image referred to in the eye opened/closed score calculation processing illustrated in FIG. 11.

A fourth exemplary embodiment will be described. In the first to third exemplary embodiments, the information processing apparatus 100 that performs biometric determination based on the blinking of a recognition target has been described. In the fourth exemplary embodiment, an example of performing biometric determination using a method different from that in the above-described exemplary embodiments will be described. In the fourth exemplary embodiment, the description will be given of an example of performing biometric determination processing of checking whether a skin color changes in accordance with pulse waves based on a face image of a recognition target, for example, and based on this, determining whether a recognition target is a living subject with pulse waves or a nonliving subject without pulse waves, such as a photograph. In the fourth exemplary embodiment, in the information processing apparatus 100 that performs biometric determination based on pulse waves of a recognition target, a method of registering a history of a pulse rate of each user as a biometric determination parameter will be described.

A hardware configuration functional blocks, and an example applicable to an information processing apparatus 100 according to the fourth exemplary embodiment are similar to those described above with reference to FIGS. 1, 2 and 4. Thus, the illustration and the description of these will be omitted. In the information processing apparatus 100 according to the fourth exemplary embodiment, the illustration and the description of flowcharts similar to those in the above-described exemplary embodiments will also be omitted. Hereinafter, the information processing apparatus 100 according to the fourth exemplary embodiment will be described mainly based on a difference from the above-described exemplary embodiments.

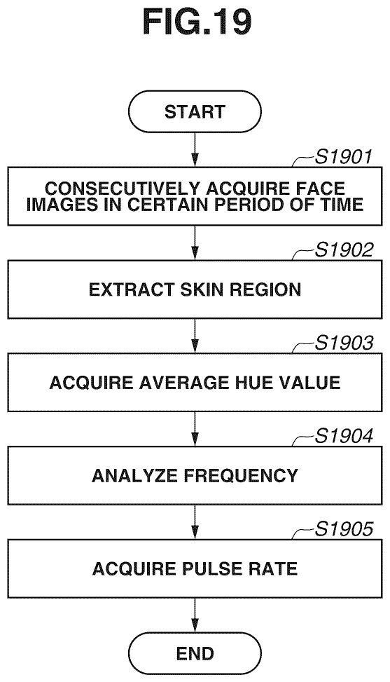

FIG. 19 is a flowchart illustrating the biometric determination parameter determination processing to be performed by the determination unit 203 in step S603 in the information processing apparatus 100 according to the fourth exemplary embodiment.

First of all, as processing in step S1901, the image acquisition unit 202 consecutively acquires face images obtained by the imaging apparatus 201 capturing images of the face of a registration target user at a fixed frame rate.

Next, as processing in step S1902, the determination unit 203 extracts a skin region by the pixel from the face image acquired in step S1901. In the skin region extraction, a desired extraction method can be used.

For example, the determination unit 203 converts a color representation of each pixel of the image into a hue, saturation, value (HSV) color space format, and extracts as a skin region a group of pixels in which the hue (H), saturation (S), and brightness (V) have values falling within a predefined specific range. Further, on the assumption that a skin region occupies a large portion of a face region, the determination unit 203 excludes a pixel with a statistically outlier among the HSV values of all the pixels in the face region, and extract a group of the remaining pixels as the skin region. Aside from this, the determination unit 203 may include an extractor that extracts a skin region of a person by the pixel that is learned using deep learning.

Next, as processing in step S1903, the determination unit 203 acquires average hue values of the skin regions extracted from the face images consecutively acquired at the fixed frame rate. Time-series data as the average hue values is thereby obtained.

Next, as processing in step S1904, the determination unit 203 obtains a frequency spectrum by performing frequency analysis on the time-series data as the hue average values. As the frequency analysis, for example, fast Fourier transformation (FFT) can be used. Before the frequency analysis, the determination unit 203 may preliminarily perform preprocessing on the time-series data as the hue average values using a window function or a bandpass filter.

After that, as processing in step S1905, the determination unit 203 estimates a pulse rate of a registration target user from the frequency spectrum obtained in step S1904. For example, the determination unit 203 estimates a frequency including a frequency component with the largest amplitude of the frequency components falling within a general human pulse rate range, as a pulse rate of the registration target user. Specifically, the determination unit 203 estimates a frequency including a frequency component with the largest amplitude of the frequency components falling within the range from 0.83 Hz to 3.33 Hz that corresponds to the range from 50 beats per minute (bpm) to 200 bpm as a pulse rate of the registration target user.

After the biometric determination parameter determination processing illustrated in FIG. 19, as processing in step S605 of FIG. 6, the information processing apparatus 100 registers the history of the pulse rate obtained in step S1905 in the storage unit 205 (database) as a biometric determination parameter of the registered user.

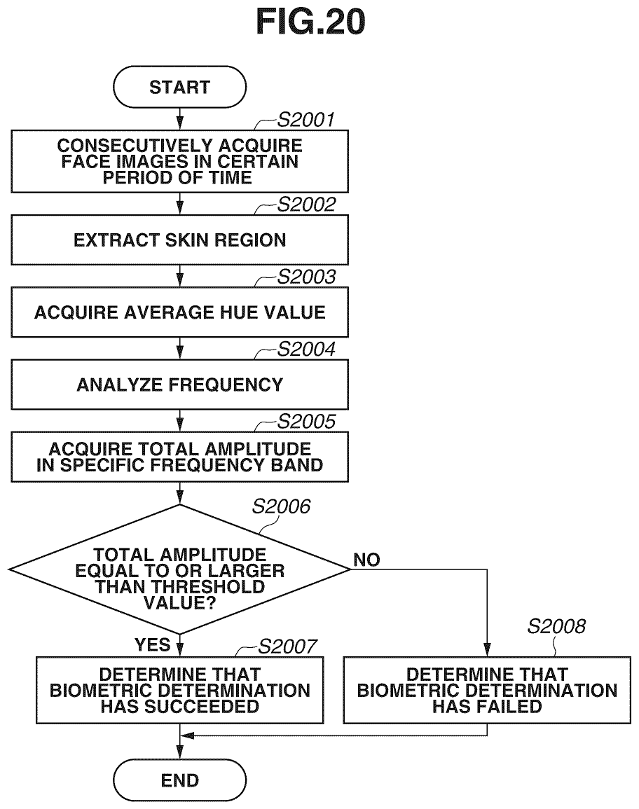

FIG. 20 is a flowchart illustrating the biometric determination processing to be performed by the determination unit 203 in step S706 in the information processing apparatus 100 according to the fourth exemplary embodiment. Processing in steps S2001 to S2004 is the same as the processing in steps S1901 to S1904 of FIG. 19, the description thereof will be omitted.

If the processing proceeds to step S2005 after step S2004, the determination unit 203 calculates the total amplitude in a specific frequency band as a pulse wave score from the frequency spectrum obtained in step S2004. First of all, the determination unit 203 determines a specific frequency band based on the history of a pulse rate of the registered user referred to in step S705 as a biometric determination parameter. For example, the determination unit 203 calculates the average value of pulse rates from the history of a pulse rate of the registered user, and determines a frequency band within a fixed range from the frequency of the average value of pulse rates to be a specific frequency band. Further, the determination unit 203 calculates a standard deviation in addition to an average value of pulse rates from the history of a pulse rate of a registered user, and further determines a frequency band falling within a range determined based on the standard deviation to be a specific frequency band from the frequency of the average value of pulse rates. The range determined based on the standard deviation is a range within twice the standard deviation on both the positive and negative sides, for example. The determination unit 203 can more favorably acquire the amplitude of an oscillating component of a skin color that is attributed to a pulse wave of a registered user.

Next, as processing in step S2006, the determination unit 203 checks whether the pulse wave score calculated in step S2005 is equal to or larger than a predetermined threshold value. The threshold value is determined by experimentally finding a threshold value that can most favorably classify a target into a living subject or a nonliving subject based on a pulse wave score calculated from the amplitude in the specific frequency band (for example, a threshold value at which an F value being a harmonic mean of precision and recall is the maximum). Then, if the pulse wave score is equal to or larger than the threshold value, the processing proceeds to step S907. On the other hand, if the pulse wave score is smaller than the threshold value, the processing proceeds to step S908.

If the processing proceeds to step S2007, similarly to step S909, the determination unit 203 determines that the biometric determination of the recognition target determined to be a registered user in the face recognition processing has succeeded, and determines that the recognition target is a registered user being a living subject. On the other hand, in the processing proceeds to step S2008, similarly to step S910, the determination unit 203 determines that the biometric determination has not succeeded.

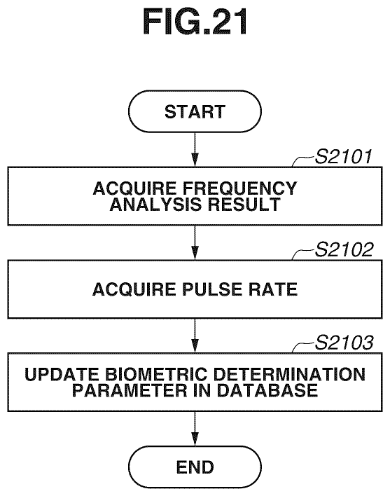

FIG. 21 is a flowchart illustrating the biometric determination parameter update processing to be performed by the determination unit 203 in step S708 in the information processing apparatus 100 according to the fourth exemplary embodiment. The biometric determination parameter update processing illustrated in FIG. 21 is performed when the determination unit 203 determines that a recognition target is a registered user being a living subject.

First of all, as processing in step S2101, the determination unit 203 refers to the frequency spectrum obtained in step S2004 in the biometric determination processing in step S706.

Next, as processing in step S2102, similarly to the processing in step S1905, the determination unit 203 estimates a pulse rate based on the frequency spectrum referred to in step S2101.

After that, as processing in step S2103, the information processing apparatus 100 registers the history of a pulse rate that has been obtained in step S2102 in the storage unit 205 (database) as a biometric determination parameter (i.e., updates the biometric determination parameter).

In the fourth exemplary embodiment, an example of registering the history of a pulse rate of a registered user as a biometric determination parameter has been described, but the information processing apparatus 100 may register another parameter for favorably performing the biometric determination that is based on pulse waves depending on each user. For example, the information processing apparatus 100 may register a pulse rate in face image registration as a reference value, and use the pulse rate in place of an average value in step S2005. Further, the information processing apparatus 100 may register a statistics amount, such as an average value or a standard deviation to be used in step S2005 in place of the history. Furthermore, similarly to the first and second exemplary embodiments, the information processing apparatus 100 may register a threshold value to be used in determination or a parameter to be used in correction of a pulse wave score.

In the fourth exemplary embodiment, the example of using a pulse wave in biometric determination has been described, but the biometric determination may be performed by combining eye opened/closed motions in the above-described first to third exemplary embodiment and pulse waves according to the fourth exemplary embodiment. Combinations of these provide a more accurate biometric determination.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-017243, filed Feb. 7, 2024, which is hereby incorporated by reference herein in its entirety.

What is claimed is:

1. An information processing apparatus comprising:
a storage device that stores a biometric determination parameter used in determining whether a person appearing in an image is a living subject;
at least one memory storing instructions; and
at least one processor that, upon execution of the stored instructions, causes the information processing apparatus to function as:
a face recognition unit that performs face recognition to determine whether a recognition target is a registered user by comparing a face feature amount acquired from a face image of the recognition target and a face feature amount of the registered user; and
a determination unit that determines whether the recognition target recognized by the face recognition as the registered user is the living subject using the stored biometric determination parameter,
wherein the stored biometric determination parameter is determined based on a detection result of an eye opened/closed motion of the registered user, and
wherein the determination unit determines whether the recognition target is the living subject, by comparing a detection result of a motion including eye opening/closing of the recognition target recognized by the face recognition as the registered user and the stored biometric determination parameter.

2. The information processing apparatus according to claim 1,
wherein the storage device stores a face image or a face feature amount of the registered user is stored in the at least one memory, and
wherein the face recognition unit performs the face recognition by comparing a face feature amount acquired from the stored face feature amount of the registered user or the stored face image of the registered user and the face feature amount acquired from the face image of the recognition target.

3. The information processing apparatus according to claim 1,
wherein the stored biometric determination parameter is a threshold value representing a detection result that detects an eye opened/closed motion of the registered user, and
wherein, when a detection result of a motion including eye opening/closing of the recognition target recognized by the face recognition as the registered user includes a detection result equal to or larger than the threshold value, the determination unit determines that the recognition target is a living subject.

4. The information processing apparatus according to claim 3, wherein execution of the stored instructions further configures the at least one processor to function as:
a parameter determination unit that determines the threshold value based on a time-series transition of detection results of eye opened/closed motions detected from face images of the registered user, and
wherein the determined threshold value corresponding to the biometric determination parameter corresponding to the registered user is caused to be stored in the at least one memory.

5. The information processing apparatus according to claim 4, wherein the parameter determination unit determines a plurality of the threshold values based on the time-series transition of the detection results of the eye opened/closed motions detected from the plurality of face images of the registered user, and determines an average value of the plurality of threshold values as the biometric determination parameter.

6. The information processing apparatus according to claim 4, wherein the parameter determination unit determines the biometric determination parameter serving as the threshold value based on a time-series transition of detection results of eye opened/closed motions detected from face images meeting a predetermined condition of the plurality of face images of the registered user.

7. The information processing apparatus according to claim 1,
wherein the stored biometric determination parameter is a coefficient for normalizing or correcting a detection result of an eye opened/closed motion, and
wherein, when the detection result obtained by normalizing or correcting, using the stored coefficient, a detection result of a motion including eye opening/closing of the recognition target recognized by the face recognition as the registered user includes a detection result equal to or larger than a predetermined threshold value, it is determined that the recognition target is a living subject.

8. The information processing apparatus according to claim 7, wherein execution of the stored instructions further configures the at least one processor to function as: a parameter determination unit configured to determine the stored biometric determination parameter serving as the coefficient of a correction formula for normalizing or correcting the detection result of the eye opened/closed motion based on a time-series transition of detection results of eye opened/closed motions from face images of the registered user,
wherein the storage device stores the coefficient determined by the parameter determination unit as the stored biometric determination parameter corresponding to the registered user.

9. The information processing apparatus according to claim 4, wherein, when it is determined that the recognition target recognized by the face recognition as the registered user is the living subject, the determination unit updates the biometric determination parameter stored in the at least one memory and which corresponds to the registered user, with the biometric determination parameter determined by the parameter determination unit based on the face image of the recognition target.

10. An information processing apparatus comprising:
a storage device that stores a biometric determination parameter used in determining whether a person appearing in an image is a living subject;
at least one memory storing instructions; and
at least one processor that, upon execution of the stored instructions, causes the information processing apparatus to function as:
a face recognition unit configured to perform face recognition to determine whether a recognition target is a registered user by comparing a face feature amount acquired from a face image of the recognition target and a face feature amount of the registered user; and
a determination unit configured to determine whether the recognition target recognized by the face recognition as the registered user is the living subject using the stored biometric determination parameter,
wherein the stored biometric determination parameter is determined based on a detection result of a pulse wave of the registered user, and
wherein the determination unit determines whether the recognition target is the living subject by comparing a detection result of a pulse wave of the recognition target recognized by the face recognition as the registered user and the stored biometric determination parameter.

11. The information processing apparatus according to claim 10,
wherein the at least one memory stores a face image or a face feature amount of the registered user, and
wherein the face recognition unit performs the face recognition by comparing a face feature amount acquired from the face image of the registered user or the face image of the registered user that is stored in the at least one memory and the face feature amount acquired from the face image of the recognition target.

12. The information processing apparatus according to claim 10,
wherein the stored biometric determination parameter is a value indicating at least either of a history of a pulse rate detected from a face image of the registered user, a reference value of the pulse rate, or a statistics amount of the pulse rate, and
wherein, when the value detected in accordance with the biometric determination parameter from the face image of the recognition target recognized by the face recognition as the registered user is equal to or larger than a predetermined threshold value, it is determined that the recognition target is the living subject.

13. The information processing apparatus according to claim 12, wherein the predetermined threshold value is a threshold value determined based on the detection result of the pulse wave of the registered user.

14. The information processing apparatus according to claim 10,
wherein the stored biometric determination parameter is a coefficient for normalizing or correcting a detection result of the pulse wave, and
wherein, when the detection result obtained by normalizing or correcting, using the coefficient, a detection result of a pulse wave of the recognition target recognized by the face recognition as the registered user includes a detection result equal to or larger than a predetermined threshold value, it is determined that the recognition target is the living subject.

15. The information processing apparatus according to claim 10,
wherein execution of the stored instructions further configures the at least one processor to function as a parameter determination unit that determines the stored biometric determination parameter based on the detection result of the pulse wave of the registered user, and
wherein the determined coefficient is caused to be stored in the at least one memory as the stored biometric determination parameter corresponding to the registered user.

16. The information processing apparatus according to claim 15, wherein, when it is determined that the recognition target recognized by the face recognition as the registered user is the living subject, the stored biometric determination parameter corresponding to the registered user stored in the at least one memory is updated with the determined biometric determination parameter based on a detection result of a pulse wave of the recognition target.

17. An information processing method comprising:
storing a biometric determination parameter to be used in determination as to whether a person appearing in an image is a living subject;
performing face recognition to determine whether a recognition target is a registered user, by comparing a face feature amount acquired from a face image of the recognition target and a face feature amount of the registered user; and
determining whether the recognition target recognized by the face recognition as the registered user is the living subject, using the stored biometric determination parameter,
wherein the stored biometric determination parameter is determined based on a detection result of an eye opened/closed motion of the registered user, and
wherein the determining determines whether the recognition target is the living subject, by comparing a detection result of a motion including eye opening/closing of the recognition target recognized by the face recognition as the registered user and the stored biometric determination parameter.

18. An information processing method comprising:
storing a biometric determination parameter to be used in determination as to whether a person appearing in an image is a living subject;
performing face recognition to determine whether a recognition target is a registered user, by comparing a face feature amount acquired from a face image of the recognition target and a face feature amount of the registered user; and
determining whether the recognition target recognized by the face recognition as the registered user is a living subject, using the stored biometric determination parameter,
wherein the stored biometric determination parameter is determined based on a detection result of a pulse wave of the registered user, and
wherein the determining determines whether the recognition target is a living subject, by comparing a detection result of a pulse wave of the recognition target recognized by the face recognition as the registered user and the stored biometric determination parameter.

19. A non-transitory computer-readable medium storing computer-executable instructions for causing a computer to execute a method comprising:
storing a biometric determination parameter to be used in determination as to whether a person appearing in an image is a living subject;
performing face recognition to determine whether a recognition target is a registered user, by comparing a face feature amount acquired from a face image of the recognition target and a face feature amount of the registered user; and
determining whether the recognition target recognized by the face recognition as the registered user is a living subject, using the stored biometric determination parameter,
wherein the stored biometric determination parameter is determined based on a detection result of an eye opened/closed motion of the registered user, and
wherein the determining determines whether the recognition target is a living subject, by comparing a detection result of a motion including eye opening/closing of the recognition target recognized by the face recognition as the registered user and the stored biometric determination parameter.

20. A non-transitory computer-readable medium storing computer-executable instructions for causing a computer to execute a method comprising:
storing a biometric determination parameter to be used in determination as to whether a person appearing in an image is a living subject;
performing face recognition to determine whether a recognition target is a registered user, by comparing a face feature amount acquired from a face image of the recognition target and a face feature amount of the registered user; and
determining whether the recognition target recognized by the face recognition as the registered user is a living subject, using the stored biometric determination parameter,
wherein the stored biometric determination parameter is determined based on a detection result of a pulse wave of the registered user, and
wherein the determining determines whether the recognition target is a living subject, by comparing a detection result of a pulse wave of the recognition target recognized by the face recognition as the registered user and the stored biometric determination parameter.
